(19) United States
(12) Patent Application Publication
(10) Pub. No.: US 2025/0386334 A1
(43) Pub. Date: Dec. 18, 2025

(54) TECHNIQUES FOR MAXIMUM PERMISSIBLE EXPOSURE COMPLIANCE

(71) Applicant: QUALCOMM Incorporated, San Diego, CA (US)

(72) Inventors: Moshe BEN-ARI, Rehovot (IL); Shay LANDIS, Hod Hasharon (IL); Yehonatan DALLAL, Kfar Saba (IL)

(21) Appl. No.: 18/742,262

(22) Filed: Jun. 13, 2024

(51) Int. Cl. H04W 72/12; H04W 16/28; H04W 72/51

(52) U.S. Cl. CPC H04W 72/12; H04W 16/28; H04W 72/51

(57) ABSTRACT

Methods, systems, and devices for wireless communications are described. Techniques described herein provide for maximum permissible exposure compliance. In some examples, a user equipment (UE) may transmit information that pertains to at least one of object detection or object classification. The UE may receive, responsive to the information, a grant that schedules object detection via one or more detection beams. The one or more detection beams may be indicated to the UE separate from one or more classification beams. The UE may attempt to detect an object using the one or more detection beams. In some examples, the UE may attempt to classify the object using the one or more classification beams.

### FIELD OF TECHNOLOGY

The following relates to wireless communications, including techniques for maximum permissible exposure compliance.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting first information that pertains to at least one of object detection or object classification, receiving, responsive to the first information, a first grant that schedules object detection via one or more first detection beams, where the one or more first detection beams are indicated to the UE separate from one or more first classification beams, and attempting to detect an object using the one or more first detection beams.

A UE for wireless communications is described. The UE may include one or more memories storing processor executable code, and one or more processors coupled with the one or more memories. The one or more processors may individually or collectively be operable to execute the code to cause the UE to transmit first information that pertains to at least one of object detection or object classification, receive, responsive to the first information, a first grant that schedules object detection via one or more first detection beams, where the one or more first detection beams are indicated to the UE separate from one or more first classification beams, and attempt to detect an object using the one or more first detection beams.

Another UE for wireless communications is described. The UE may include means for transmitting first information that pertains to at least one of object detection or object classification, means for receiving, responsive to the first information, a first grant that schedules object detection via one or more first detection beams, where the one or more first detection beams are indicated to the UE separate from one or more first classification beams, and means for attempting to detect an object using the one or more first detection beams.

A non-transitory computer-readable medium storing code for wireless communications is described. The code may include instructions executable by one or more processors to transmit first information that pertains to at least one of object detection or object classification, receive, responsive to the first information, a first grant that schedules object detection via one or more first detection beams, where the one or more first detection beams are indicated to the UE separate from one or more first classification beams, and attempt to detect an object using the one or more first detection beams.

In some examples of the method, user equipment (UEs), and non-transitory computer-readable medium described herein, the first information includes a first request for a detection beam grant, the first grant may be responsive to the first request for the detection beam grant.

Some examples of the method, user equipment (UEs), and non-transitory computer-readable medium described herein may further include operations, features, means, or instructions for transmitting, based on detection of the object using the one or more first detection beams, second information that includes a second request for a classification beam grant for classification of the object, receiving, responsive to the second information, a second grant that schedules object classification via the one or more first classification beams, and attempting to classify the object using the one or more first classification beams.

In some examples of the method, user equipment (UEs), and non-transitory computer-readable medium described herein, the first information includes a first request for a detection beam grant and a classification beam grant, the first grant may be responsive to the first request for the detection beam grant and the classification beam grant, the first grant schedules object classification via the one or more first classification beams.

In some examples of the method, user equipment (UEs), and non-transitory computer-readable medium described herein, the first grant may be a set of multiple grants that may be collectively responsive to the first request, each of the set of multiple grants schedules respective beams of the one or more first detection beams or the one or more first classification beams.

Some examples of the method, user equipment (UEs), and non-transitory computer-readable medium described herein may further include operations, features, means, or instructions for attempting, based on detection of the object using the one or more first detection beams, to classify the object using the one or more first classification beams.

In some examples of the method, user equipment (UEs), and non-transitory computer-readable medium described herein, the first information includes a first request for a set of multiple detection beam grants, the first grant may be a set of multiple grants that may be collectively responsive to the first request, each of the set of multiple grants schedules respective beams of the one or more first detection beams.

Some examples of the method, user equipment (UEs), and non-transitory computer-readable medium described herein may further include operations, features, means, or instructions for transmitting, based on detection of the object using the one or more first detection beams, second information that includes a second request for a set of multiple classification beam grants for classification of the object, receiving, responsive to the second information, a second grant, where the second grant may be a set of multiple classification beam grants that may be collectively responsive to the second request, where each of the set of multiple classification beam grants schedules respective beams of the one or more first classification beams, and attempting to classify the object using the one or more first classification beams.

In some examples of the method, user equipment (UEs), and non-transitory computer-readable medium described herein, the first information includes a first request for a set of multiple a detection beam grants and a set of multiple classification beam grants for classification of the object, the first grant may be a set of multiple detection beam grants and a set of multiple classification beam grants that may be collectively responsive to the first request, each of the set of multiple detection beam grants schedules respective beams of the one or more first detection beams and each of the set of multiple classification beam grants schedules respective beams of the one or more first classification beams.

Some examples of the method, user equipment (UEs), and non-transitory computer-readable medium described herein may further include operations, features, means, or instructions for attempting to classify the object using the one or more first classification beams, where the set of multiple detection beam grants and the set of multiple classification beam grants collectively schedules all of the respective beams of the one or more first detection beams to be used prior to use of any respective beams of the one or more first classification beams.

Some examples of the method, user equipment (UEs), and non-transitory computer-readable medium described herein may further include operations, features, means, or instructions for attempting to classify the object using the one or more first classification beams, where the set of multiple detection beam grants and the set of multiple classification beam grants collectively schedules the respective beams of the one or more first detection beams to be used temporally interspersed with use of the respective beams of the one or more first classification beams.

In some examples of the method, user equipment (UEs), and non-transitory computer-readable medium described herein, the first information includes a first request for a periodic detection beam grant and a periodic classification beam grant, the first grant may be responsive to the first request for the periodic detection beam grant and the periodic classification beam grant, the first grant schedules periodic object detection via the one or more first detection beams, and the first grant schedules periodic object classification via the one or more first classification beams.

Some examples of the method, user equipment (UEs), and non-transitory computer-readable medium described herein may further include operations, features, means, or instructions for transmitting, subsequent to receiving the first grant, second information that indicates a request to end the periodic detection beam grant and the periodic classification beam grant.

In some examples of the method, user equipment (UEs), and non-transitory computer-readable medium described herein, the first grant may be a set of multiple grants that may be collectively responsive to the first request, each of the set of multiple grants schedules respective beams of the one or more first detection beams or the one or more first classification beams.

In some examples of the method, user equipment (UEs), and non-transitory computer-readable medium described herein, the first information includes a capability report that pertains to object detection and object classification.

In some examples of the method, user equipment (UEs), and non-transitory computer-readable medium described herein, the first grant schedules periodic object detection via the one or more first detection beams and periodic object classification via the one or more first classification beams based on the capability report.

In some examples of the method, user equipment (UEs), and non-transitory computer-readable medium described herein, the first grant may be a set of multiple grants that may be collectively responsive to the first request, each of the set of multiple grants schedules respective beams of the one or more first detection beams or the one or more first classification beam.

In some examples of the method, user equipment (UEs), and non-transitory computer-readable medium described herein, object classification includes object identification.

Some examples of the method, user equipment (UEs), and non-transitory computer-readable medium described herein may further include operations, features, means, or instructions for attempting to classify the object using the one or more first classification beams based on detection of the object using the one or more first detection beams and complying with a maximum permissible exposure (MPE) restriction based on classification of the object using the one or more first classification beams.

In some examples of the method, user equipment (UEs), and non-transitory computer-readable medium described herein, complying with the MPE restriction may include operations, features, means, or instructions for refraining from transmitting a beam that may be directed to the object.

In some examples of the method, user equipment (UEs), and non-transitory computer-readable medium described herein, complying with the MPE restriction may include operations, features, means, or instructions for transmitting a beam that may be directed to the object at higher power backoff or a lower duty cycle than a beam that may be directed away from the object.

In some examples of the method, user equipment (UEs), and non-transitory computer-readable medium described herein, the one or more first detection beams include a beam in a millimeter wave (mmW) frequency range or a sub-terahertz (sub-THz) frequency range.

In some examples of the method, user equipment (UEs), and non-transitory computer-readable medium described herein, the one or more first classification beams include a beam in a sub-THz frequency range.

A method for wireless communications by a network entity is described. The method may include obtaining first information that pertains to at least one of object detection or object classification and outputting, responsive to the first information, a first grant that schedules object detection via one or more first detection beams, where the one or more first detection beams are indicated to the UE separate from one or more first classification beams.

A network entity for wireless communications is described. The network entity may include one or more memories storing processor executable code, and one or more processors coupled with the one or more memories. The one or more processors may individually or collectively be operable to execute the code to cause the network entity to obtain first information that pertains to at least one of object detection or object classification and output, responsive to the first information, a first grant that schedules object detection via one or more first detection beams, where the one or more first detection beams are indicated to the UE separate from one or more first classification beams.

Another network entity for wireless communications is described. The network entity may include means for obtaining first information that pertains to at least one of object detection or object classification and means for outputting, responsive to the first information, a first grant that schedules object detection via one or more first detection beams, where the one or more first detection beams are indicated to the UE separate from one or more first classification beams.

A non-transitory computer-readable medium storing code for wireless communications is described. The code may include instructions executable by one or more processors to obtain first information that pertains to at least one of object detection or object classification and output, responsive to the first information, a first grant that schedules object detection via one or more first detection beams, where the one or more first detection beams are indicated to the UE separate from one or more first classification beams.

In some examples of the method, network entities, and non-transitory computer-readable medium described herein, the first information includes a first request for a detection beam grant, the first grant may be responsive to the first request for the detection beam grant.

Some examples of the method, network entities, and non-transitory computer-readable medium described herein may further include operations, features, means, or instructions for obtaining, subsequent the first information, second information that includes a second request for a classification beam grant for classification of an object and outputting, responsive to the second information, a second grant that schedules object classification via the one or more first classification beams.

In some examples of the method, network entities, and non-transitory computer-readable medium described herein, the first information includes a first request for a set of multiple detection beam grants, the first grant may be a set of multiple grants that may be collectively responsive to the first request, each of the set of multiple grants schedules respective beams of the one or more first detection beams.

Some examples of the method, network entities, and non-transitory computer-readable medium described herein may further include operations, features, means, or instructions for obtaining, subsequent the first information, second information that includes a second request for a set of multiple classification beam grants for classification of an object and outputting, responsive to the second information, a second grant, where the second grant may be a set of multiple classification beam grants that may be collectively responsive to the second request, where each of the set of multiple classification beam grants schedules respective beams of the one or more first classification beams.

In some examples of the method, network entities, and non-transitory computer-readable medium described herein, the first information includes a first request for a set of multiple detection beam grants and a set of multiple classification beam grants for classification of an object, the first grant may be a set of multiple detection beam grants and a set of multiple classification beam grants that may be collectively responsive to the first request, each of the set of multiple detection beam grants schedules respective beams of the one or more first detection beams and each of the set of multiple classification beam grants schedules respective beams of the one or more first classification beams.

In some examples of the method, network entities, and non-transitory computer-readable medium described herein, the first information includes a first request for a periodic detection beam grant and a periodic classification beam grant, the first grant may be responsive to the first request for the periodic detection beam grant and the periodic classification beam grant, the first grant schedules periodic object detection via the one or more first detection beams, the first grant schedules periodic object classification via the one or more first classification beams.

Some examples of the method, network entities, and non-transitory computer-readable medium described herein may further include operations, features, means, or instructions for obtaining, subsequent to the first information, second information that indicates a request to end the periodic detection beam grant and the periodic classification beam grant.

In some examples of the method, network entities, and non-transitory computer-readable medium described herein, the first grant may be a set of multiple grants that may be collectively responsive to the first request, each of the set of multiple grants schedules respective beams of the one or more first detection beams or the one or more first classification beams.

In some examples of the method, network entities, and non-transitory computer-readable medium described herein, the first information includes a capability report that pertains to object detection and object classification.

In some examples of the method, network entities, and non-transitory computer-readable medium described herein, the first grant schedules periodic object detection via the one or more first detection beams and periodic object classification via the one or more first classification beams based on the capability report.

In some examples of the method, network entities, and non-transitory computer-readable medium described herein, the first grant may be a set of multiple grants that may be collectively responsive to the first request, each of the set of multiple grants schedules respective beams of the one or more first detection beams or the one or more first classification beams.

In some examples of the method, network entities, and non-transitory computer-readable medium described herein, object classification includes object identification.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for maximum permissible exposure (MPE) compliance in accordance with one or more aspects of the present disclosure.

FIG. 2 shows an example of a wireless communications system that supports techniques for MPE compliance in accordance with one or more aspects of the present disclosure.

FIG. 3 shows examples of signaling diagrams that support techniques for MPE compliance in accordance with one or more aspects of the present disclosure.

FIG. 4 shows examples of signaling diagrams that support techniques for MPE compliance in accordance with one or more aspects of the present disclosure.

FIG. 5 shows examples of signaling diagrams that support techniques for MPE compliance in accordance with one or more aspects of the present disclosure.

FIG. 6 shows an example of a signaling diagram that supports techniques for MPE compliance in accordance with one or more aspects of the present disclosure.

FIG. 7 shows an example of a process flow that supports techniques for MPE compliance in accordance with one or more aspects of the present disclosure.

FIGS. 8 and 9 show block diagrams of devices that support techniques for MPE compliance in accordance with one or more aspects of the present disclosure.

FIG. 10 shows a block diagram of a communications manager that supports techniques for MPE compliance in accordance with one or more aspects of the present disclosure.

FIG. 11 shows a diagram of a system including a device that supports techniques for MPE compliance in accordance with one or more aspects of the present disclosure.

FIGS. 12 and 13 show block diagrams of devices that support techniques for MPE compliance in accordance with one or more aspects of the present disclosure.

FIG. 14 shows a block diagram of a communications manager that supports techniques for MPE compliance in accordance with one or more aspects of the present disclosure.

FIG. 15 shows a diagram of a system including a device that supports techniques for MPE compliance in accordance with one or more aspects of the present disclosure.

FIGS. 16 through 18 show flowcharts illustrating methods that support techniques for MPE compliance in accordance with one or more aspects of the present disclosure.

### DETAILED DESCRIPTION

Some wireless communications systems may deploy network entities and user equipments. In some cases, the network entity and user equipment (UE) may communicate in Frequency Range 2 (FR2) or Frequency Range 3 (FR3) using controlled narrow direction beams having high power density. Maximum permissible exposure (MPE) is a physical measured value related to electric and magnetic field strength and power density of device transmitted signals. Regulations may limit the MPE of the radio frequency (RF) radiation exposure to human tissues. RF radiation exposure exceeding the MPE regulation may occur in any frequency band, and in FR2 and FR3, the exposure hazard to human tissues from directional beams may be higher than the MPE set by regulations. In some cases, a human holding the UE may block beams transmitted by the UE and may violate the MPE regulation. As power density is based on radiated power, beam width, and distance, techniques may be used to detect and avoid objects near the UE within the direction of a possible beam transmission. In some cases, the detected object may not be human tissue and thus the object might not violate the MPE regulation. Identification and classification of an object as human tissue may increase the communication efficiency while complying with the MPE regulation.

Techniques for MPE compliance may be employed to detect and classify an object as human tissue. In particular, a UE may receive one or more grants that individually or collectively schedule the use of beams at the UE to detect and classify an object. One or more beams may be granted for use in detecting a presence of an object. Separately, one or more beams may be granted for use in classifying a detected object. Classification may also include identifying the detected object. The use of different beams as detection beams or classification beams may be beneficial. For example, classification or identification of an object might be performed using sub-terahertz bands. On the other hand, either millimeter-wave or sub-terahertz bands may be used for object detection. The granted beams for each wavelength may thus vary. Accordingly, different methods are explained herein for providing grants to a UE for separate detection beams and classification beams.

For example, the UE may receive one or more grants pertaining to the detection of the object or the classification of an object. The UE may attempt to detect the object by transmitting a detection beam in accordance with the one or more grants. In some cases, if the UE detects the object, the UE may attempt to classify or identify the object by transmitting a classification beam in accordance with the one or more grants. In some cases, the UE may transmit a single grant request for a grant of the detection beam, and the UE may transmit a single grant request for a grant of the classification beam. In some examples, the UE may transmit a combined grant request for single grants of both the detection beam and the classification beam. In some cases, the UE may transmit a multiple-grant request for grants of multiple detection beams and a multiple-grant request for grants of multiple classification beams. In some examples, the UE may transmit multiple combined-grant requests for grants of multiple detection beams and grants of multiple classification beams. In some cases, the UE may transmit a periodic multiple combined-grant request.

Aspects of the disclosure are initially described in the context of wireless communications systems. Aspects of the disclosure are also described in context of signaling diagrams and a process flow. Aspects of the disclosure are further illustrated by and described with reference to apparatus diagrams, system diagrams, and flowcharts that relate to techniques for MPE compliance.

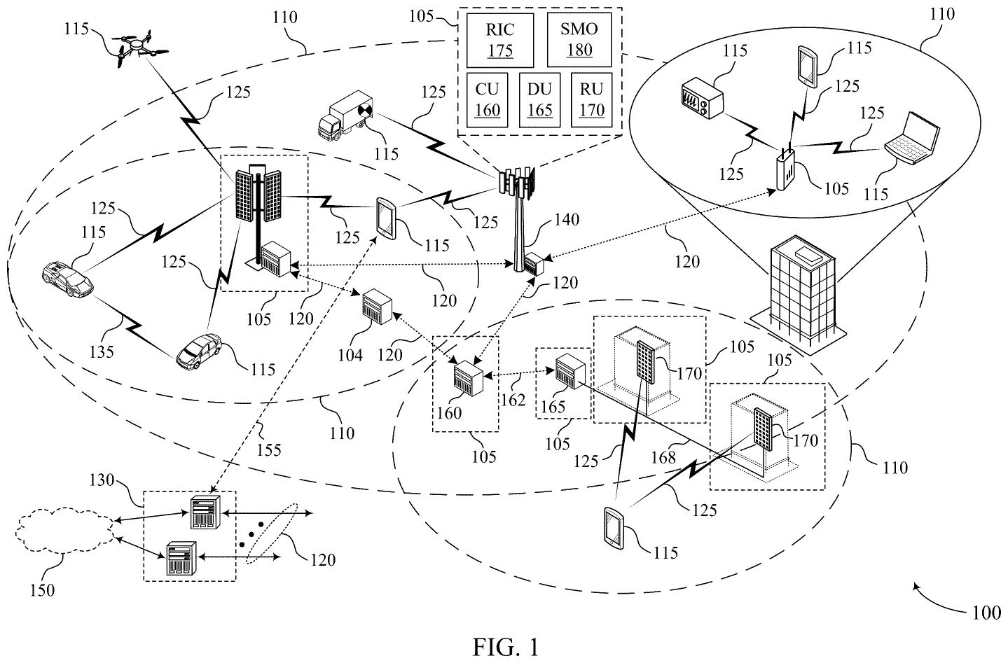

FIG. 1 shows an example of a wireless communications system 100 that supports techniques for MPE compliance in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications system may deploy network entities 105 and UEs 115. In some cases, the network entity 105 and UE 115 may communicate in Frequency Range 2 (FR2) or Frequency Range 3 (FR3) using controlled narrow direction beams having high power density. Maximum permissible exposure (MPE) is a physical measured value related to electric and magnetic field strength and power density of device transmitted signals. Regulations may limit the MPE of the radio frequency RF radiation exposure to human tissues. RF radiation exposure exceeding the MPE regulation may occur in any frequency band, and in FR2 and FR3, the exposure hazard to human tissues from directional beams may be higher than the MPE set by regulations. In some cases, a human holding the UE 115 may block beams transmitted by the UE 115 and may violate the MPE regulation. As power density is based on radiated power, beam width, and distance, techniques may be used to detect and avoid objects nearby the UE 115 within the direction of a possible beam transmission. In some cases, the detected object may not be human tissue and thus the object may not need to be avoided to satisfy the MPE regulation. Identification and classification of an object as human tissue may increase the communication efficiency while complying with the MPE regulation.

Techniques for MPE compliance may be employed to detect and classify an object as human tissue. For example, the UE 115 may transmit information that pertains to at least one of object detection or object classification. The UE 115 may receive one or more grants pertaining to the detection of the object or the classification of the object. The UE 115 may attempt to detect the object by transmitting a detection beam using the one or more grants. In some cases, if the UE 115 detects the object, the UE 115 may attempt to classify or identify the object by transmitting a classification beam using the one or more grants. In some cases, the UE 115 may transmit a single grant request for a grant of the detection beam, and the UE 115 may transmit a single grant request for a grant of the classification beam. In some examples, the UE 115 may transmit a combined single grant request for the grants of both the detection beam and the classification beam. In some cases, the UE 115 may transmit a multiple grants request for grants of multiple detection beams and a multiple grants request for grants for multiple classification beams. In some examples, the UE 115 may transmit multiple combined grants request for grants of multiple detection beams and grants of multiple classification beams. In some cases, the UE 115 may transmit a periodic multiple combined grants request.

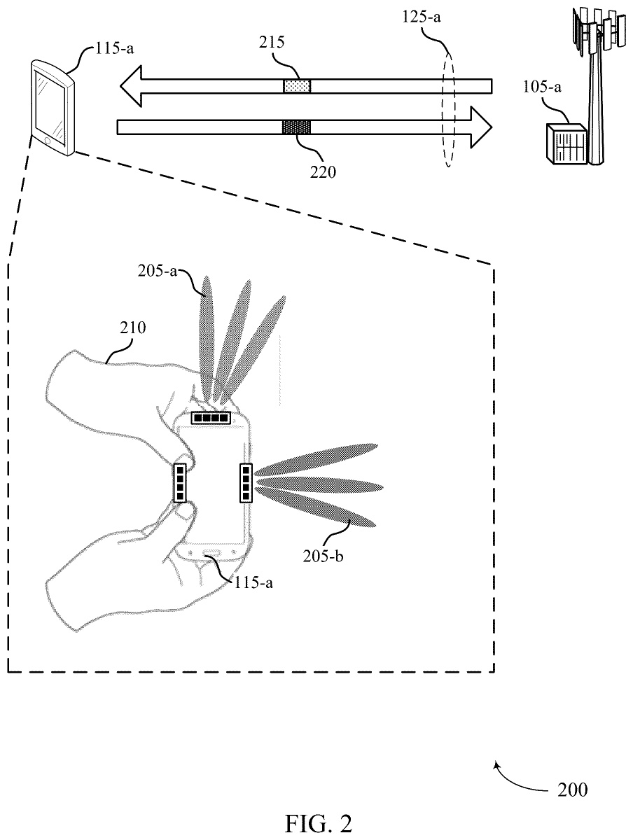

FIG. 2 shows an example of a wireless communications system 200 that supports techniques for MPE compliance in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of a 6th generation (6G), a NR or LTE link between the UE 115-a and the network entity 105-a. The communication link 125-a may include bi-directional links that enable both uplink and downlink communications. For example, the network entity 105-a may transmit downlink signals (e.g., downlink transmission 215), such as downlink control signaling and downlink data signals, to the UE 115-a using the communication link 125-a, and the UE 115-a may transmit uplink signals (e.g., uplink transmission 220), including uplink control signaling and uplink data signals to the network entity 105-a using the communication link 125-a.

In some cases, the network entity 105-a and UE 115-a may communicate in FR2 or FR3 using the communication link 125-a. The UE 115-a may communicate using controlled narrow direction beams (e.g., beam 205-a, beam 205-b, and other directional beams) having high power density. MPE is a physical measured value related to electric and magnetic field strength and power density of device transmitted signals. Regulations may limit the MPE of the radio frequency RF radiation exposure to human tissues and therefore the amount of hazard exposed to the human tissues. In FR2 and FR3, based on high frequencies (e.g., mmW, sub-terahertz (sub-THz) and above) exposure hazard to human tissues may be higher than the MPE set by regulations. As power density is based on radiated power, beam width and distance from the transmitting antenna, methods may be developed in order to determine if the UE 115 is nearby an object within the direction of a beam for transmission.

In some cases, a human 210 holding the UE 115-a may block beams transmitted by the UE 115-a and may violate MPE regulation. For example, the human 210, such as a hand or fingers, may block the beam 205-a, and the human may not block the beam 205-b. The human 210 has exposure to the beam 205-a, and the human 210 does not have exposure to the beam 205-b. Techniques may be used to detect and avoid the human 210 within the direction of a possible beam transmission (e.g., beam 205-a). In some cases, the UE 115-a may transmit a high bandwidth uplink waveform in order to achieve high timing and distance resolution, and the UE 115-a may function as RADAR. Analysis of the received signal may determine if there is an object in the path of the beam (e.g., beam 205-a) and the distance of the object from the UE 115-a. If an object is detected, the UE 115-a may use higher power backoff (BO) for the beam 205-a, the UE 115-a may transmit with a lower duty cycle for the beam 205-a, or the UE may avoid transmitting the beam 205-a for MPE compliance. In some examples, the detection and avoidance procedure may be performed periodically. Dynamic control of the beams used for object detection and object classification or identification may be balanced with communication efficiency (e.g., using the most efficient beam to communicate with the network entity 105-a) and complying with MPE regulation.

In some examples, the UE 115-a may identify what kind of object is in the path of the beam 205-a. While MPE regulation is aimed to prevent RF hazards to human tissues, any object with sufficient radiation reflection may be recognized as an obstacle or blocker and may trigger the avoidance mechanism. In some cases, an identification or classification of the object detected as human tissue may increase communication efficiency. If the detected object is not human tissue or not part of the MPE regulatory subject, the avoidance mechanisms may not be used. By detecting the object and identify or classifying the object as human tissue may increase the communication efficiency as the avoidance mechanisms may be used when human tissue is present for MPE compliance and the beam 205-a may be transmitted when the detected object is not human tissue.

A spectrogram is a visual representation of a spectrum of frequencies of a signal as the signal varies with time. Digital processing of the spectrogram may be used for identification or classification of objects. In some cases, the identification or classification of physiological parameters may be determined using the sub-THz bands by spectrogram. The spectrogram may be used to determine if the detected object blocking a transmission beam is a human tissue. In some examples, the UE 115-a may implement the spectrogram to determine (e.g., identify or classify) whether the object blocking a transmission is human tissue. If the UE 115-a identifies or classifies the detected object as human tissue, the UE 115-a may implement the avoidance mechanisms to comply with the MPE regulation.

In some examples, the UE 115-a may separate the detection tasks and identification or classification tasks. The detection task may aim for object detection within a specific beam, and the identification or classification task may aim to identify or classify the detected object as a human tissue with another beam. If the UE 115-a identifies or classifies the object as a human tissue, the UE 115-a may involve measures to avoid violating MPE regulations. In some cases, the network entity 105-a may grant the UE 115-a with detection uplink beams with parameters for the object detection task. In some cases, the network entity 105-a may grant the UE 115-a with identification or classification beams with parameters for the identification or the classification task. The separate detection task and identification or classification task may enable complying with strict MPE regulation as some blockers are not human tissue to avoid for MPE compliance. The separation of detection task and identification or classification task may enable complying with MPE regulation with more sufficient uplink power and scheduling scheme. The separation of detection task and identification or classification task may enable complying with MPE regulation with more efficient network message exchange.

In some examples, the UE 115-a may transmit dedicated uplink beams for detection of a close object within each beam and a distance associated with the beam. For object detection, the beams may use either mmW or sub-THz bands. The UE 115-a may transmit dedicated uplink beams for classification or identification of the detected object as human tissue. For object identification or classification as human tissue, the beams may use sub-THz bands. Each task of object detection and object classification or identification may involve a different waveform. The non-data uplink transmissions for object detection and object classification or identification may interfere with network entity 105-a or other UEs transmissions and receptions. Even with no such interference, the non-data uplink transmissions for object detection and object classification or identification may collide with the UE 115-a data transmissions and receptions. As a result, non-data uplink transmissions for object detection and object classification or identification may be scheduled appropriately to avoid interference or collisions. The scheduling of the non-data uplink transmissions for object detection and object classification or identification may be handled as transmission grants from the network entity 105-a. The transmission grants for the non-data uplink transmissions for object detection and object classification or identification may be given as part of dedicated message exchange between the UE 115-a and the network entity 105-a.

In some cases, the UE 115-a may transmit, to the network entity 105-a, a dedicated request for detection beam grants and classification or identification beam grant separately. In some cases, the UE 115-a may transmit, to the network entity 105-a, a dedicated combined request for detection beam and classification or identification beam grants (e.g., reducing uplink requests). In some examples, the UE 115-a may transmit, to the network entity 105-a, a dedicated request for multiple beams for detection and/or classification or identification beams grants (e.g., further reducing uplink requests). In some examples, the UE 115-a may transmit, to the network entity 105-a, a dedicated request for periodic multiple beams for detection and/or classification or identification beams grants until transmitting a stop request (e.g., further reducing uplink requests). In some examples, the UE 115-a may transmit, to the network entity 105-a, a capability report indicating the detection and/or classification or identification capabilities on registration to the network or network entity 105-a. Based on the capability report, the UE 115-a may receive periodic multiple beams for detection and/or classification or identification beams grants without a separate request.

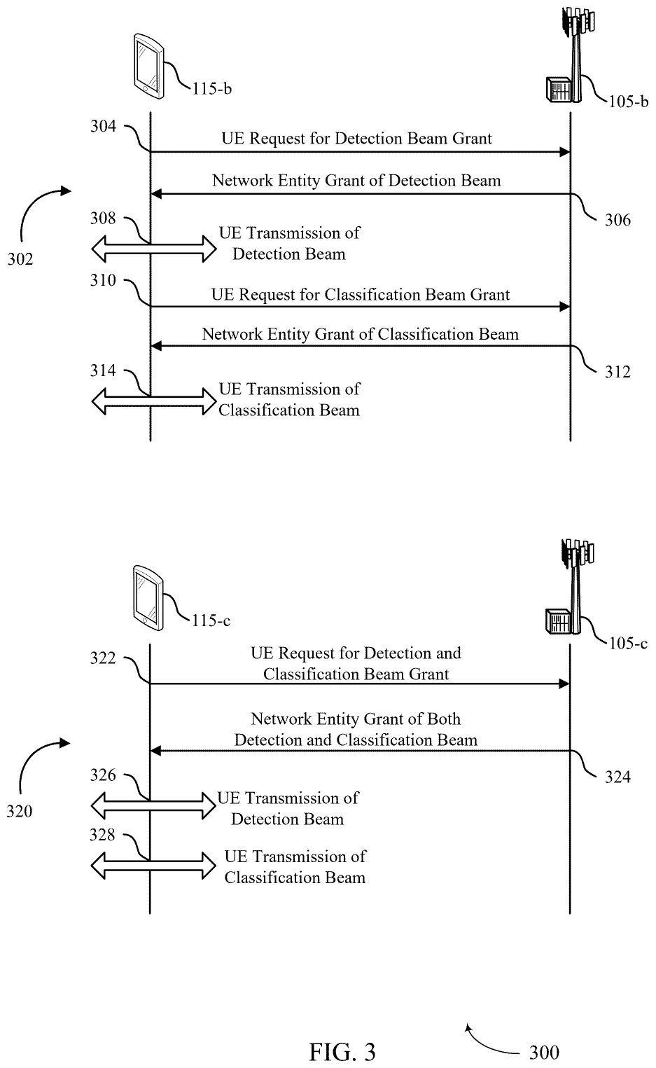

FIG. 3 shows examples of signaling diagrams 300 that supports techniques for MPE compliance in accordance with one or more aspects of the present disclosure. Aspects of the signaling diagrams 300 may implement, or be implemented by, aspects of wireless communications system 100 and the wireless communications system 200, or any combination thereof. For example, the signaling diagrams 300 may be implemented by a network entity 105-b and a network entity 105-c, which may be an example of the network entities 105 as described with reference to FIGS. 1 and 2. The signaling diagrams 300 may be implemented by a UE 115-b and a UE 115-c, which may be an example of the UEs 115 as described with reference to FIGS. 1 and 2.

In some examples, a signaling diagram 302 illustrates a single grant request. At 304, the UE 115-b may transmit a request for a detection beam grant. At 306, the UE 115-b may receive a grant of the detection beam. For example, UE 115-b may receive, from the network entity 105-b, a network grant that schedules object detection via one or more detection beams. At 308, the UE 115-b may transmit the one or more detection beams to attempt to detect an object. At 310, if the UE 115-b detects the object using the one or more detection beams, the UE 115-b may transmit a request for a classification beam grant. At 312, the UE 115-b may receive a grant of the classification beam. For example, the UE 115-b may receive, from the network entity 105-b, a network grant that schedules object classification via one or more classification beams. At 314, the UE 115-b may transmit the one or more classification beams to attempt to classify the object, such as classify or identify the object as human tissue.

In some examples, a signaling diagram 320 illustrates a combined single grant request. At 322, the UE 115-c may transmit a request for a detection and classification beam grant. At 324, the UE 115-c may receive a grant of both the detection beam and the classification beam. For example, UE 115-c may receive, from the network entity 105-c, a network grant that schedules object detection via one or more detection beams and that schedules object classification via one or more classification beams. In some cases, the UE 115-c may receive a single grant, such as a single downlink control information (DCI), scheduling multiple future detection beams and classification beams. In some cases, the UE 115-c may receive a plurality of grants, such as multiple DCIs, that each schedule one or more detection beams or one or more classification beams. At 326, the UE 115-c may transmit the one or more detection beams to attempt to detect an object. At 328, if the UE 115-c detects the object using the one or more detection beams, the UE 115-c may transmit the one or more classification beams to attempt to classify the object, such as classify or identify the object as human tissue or not human tissue.

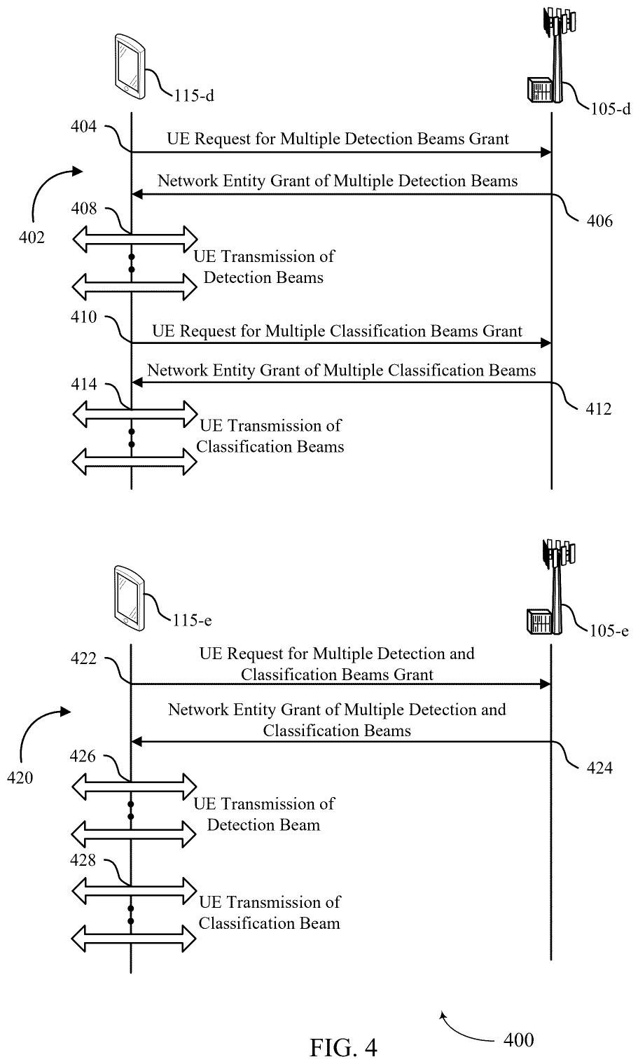

FIG. 4 shows examples of signaling diagrams 400 that supports techniques for MPE compliance in accordance with one or more aspects of the present disclosure. Aspects of the signaling diagrams 400 may implement, or be implemented by, aspects of wireless communications system 100 and the wireless communications system 200, or any combination thereof. For example, the signaling diagrams 400 may be implemented by a network entity 105-d and a network entity 105-e, which may be an example of the network entities 105 as described with reference to FIGS. 1 and 2. The signaling diagrams 400 may be implemented by a UE 115-d and a UE 115-e, which may be an example of the UEs 115 as described with reference to FIGS. 1 and 2.

In some examples, a signaling diagram 402 illustrates a multiple grants request. At 404, the UE 115-d may transmit a request for a multiple detection beams grant. At 406, the UE 115-d may receive a grant of the multiple detection beams. For example, UE 115-d may receive, from the network entity 105-d, a network grant that schedules object detection via multiple detection beams. In some cases, the UE 115-d may receive a single DCI scheduling multiple future detection beams. In some cases, the UE 115-d may receive a plurality of grants, such as multiple DCIs, that each schedule one or more detection beams. At 408, the UE 115-d may transmit the multiple detection beams to attempt to detect an object. At 410, if the UE 115-d detects one or more objects using the detection beams, the UE 115-d may transmit a request for a multiple classification beams grant. At 412, the UE 115-d may receive a grant of the multiple classification beams. For example, UE 115-d may receive, from the network entity 105-d, a network grant that schedules object classification via multiple classification beams. In some cases, the UE 115-d may receive a single DCI scheduling multiple future classification beams. In some cases, the UE 115-d may receive a plurality of grants, such as multiple DCIs, that each schedule one or more classification beams. At 414, the UE 115-d may transmit the multiple classification beams to attempt to classify the detected one or more objects, such as classify or identify the one or more objects as human tissue or not human tissue.

In some examples, a signaling diagram 420 illustrates a multiple combined grants request. At 422, the UE 115-e may transmit a request for a multiple detection and classification beams grant. At 424, the UE 115-e may receive a grant of the multiple detection and classification beams. For example, UE 115-e may receive, from the network entity 105-e, a network grant that schedules object detection via multiple detection beams and that schedules object classification via multiple classification beams. In some cases, the UE 115-e may receive a single DCI scheduling multiple future detection beams and multiple future classification beams. In some cases, the UE 115-e may receive a plurality of grants, such as multiple DCIs, that each schedule one or more detection beams or one or more classification beams. At 426, the UE 115-e may transmit the multiple detection beams to attempt to detect one or more objects. At 428, if the UE 115-e detects the one or more objects using the detection beams, the UE 115-e may transmit the multiple classification beams to attempt to classify the one or more objects, such as classify or identify the one or more objects as human tissue or not human tissue.

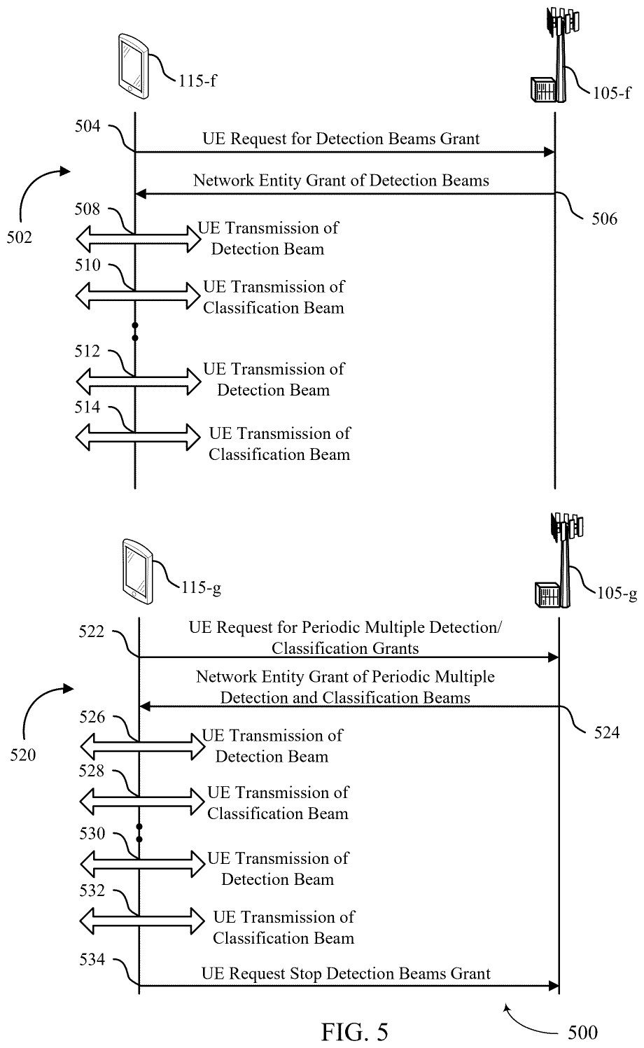

FIG. 5 shows examples of signaling diagrams 500 that supports techniques for MPE compliance in accordance with one or more aspects of the present disclosure. Aspects of the signaling diagrams 500 may implement, or be implemented by, aspects of wireless communications system 100 and the wireless communications system 200, or any combination thereof. For example, the signaling diagrams 500 may be implemented by a network entity 105-f and a network entity 105-g, which may be an example of the network entities 105 as described with reference to FIGS. 1 and 2. The signaling diagrams 500 may be implemented by a UE 115-f and a UE 115-g, which may be an example of the UEs 115 as described with reference to FIGS. 1 and 2.

In some examples, a signaling diagram 502 illustrates another example of a multiple combined grants request. At 504, the UE 115-f may transmit a request for a multiple detection and classification beams grant. At 506, the UE 115-f may receive a grant of the multiple detection and classification beams. For example, UE 115-f may receive, from the network entity 105-f, a network grant that schedules object detection via multiple detection beams and that schedules object classification via multiple classification beams. In some cases, the UE 115-f may receive a single DCI scheduling multiple future detection beams and multiple future classification beams. In some cases, the UE 115-f may receive a plurality of grants, such as multiple DCIs, that each schedule one or more detection beams or one or more classification beams. At 508, the UE 115-f may transmit one or more of the multiple detection beams to attempt to detect an object. At 510, if the UE 115-f detects the object using the detection beam, the UE 115-f may transmit one or more of the multiple classification beams to attempt to classify the object, such as classify or identify the object as human tissue. At 512, the UE 115-f may transmit one or more of the multiple detection beams to attempt to detect an object. At 514, if the UE 115-f detects the object using the detection beam, the UE 115-f may transmit one or more of the multiple classification beams to attempt to classify the object, such as classify or identify the object as human tissue. In some cases, multiple pairs of one or more detection beams and one or more classification beams may be transmitted.

In some examples, a signaling diagram 520 illustrates a periodic multiple combined grants request. At 522, the UE 115-g may transmit a request for periodic multiple detection beams and classification beams grants. At 524, the UE 115-g may receive a grant of periodic multiple detection and classification beams. For example, UE 115-g may receive, from the network entity 105-g, a network grant that schedules periodic object detection via multiple detection beams and that schedules periodic object classification via multiple classification beams. In some cases, the UE 115-g may receive a single DCI or multiple DCI scheduling multiple future periodic detection beams and multiple future periodic classification beams. At 526, the UE 115-g may transmit one or more detection beams to attempt to detect an object. At 528, if the UE 115-g detects the object using the detection beam, the UE 115-g may transmit one or more classification beams to attempt to classify the object, such as classify or identify the object as human tissue. At 530, the UE 115-g may transmit one or more detection beams to attempt to detect an object. At 532, if the UE 115-g detects the object using the detection beam, the UE 115-g may transmit one or more classification beams to attempt to classify the object, such as classify or identify the object as human tissue. At 534, the UE 115-g may transmit a request to stop the detection and classification beam grant.

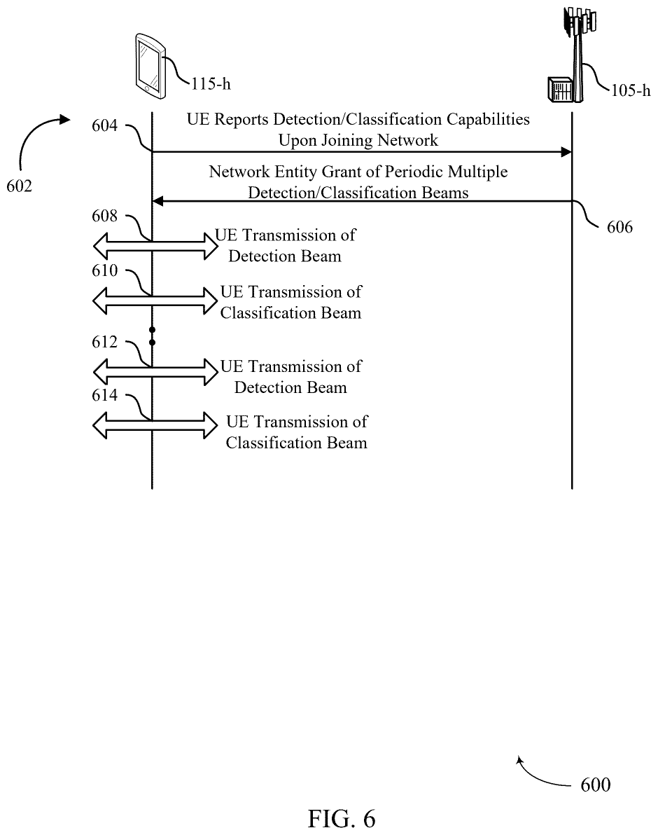

FIG. 6 shows an example of a signaling diagram 600 that supports techniques for MPE compliance in accordance with one or more aspects of the present disclosure. Aspects of the signaling diagram 600 may implement, or be implemented by, aspects of wireless communications system 100 and the wireless communications system 200, or any combination thereof. For example, the signaling diagram 600 may be implemented by a network entity 105-h, which may be an example of the network entities 105 as described with reference to FIGS. 1 and 2. The signaling diagram 600 may be implemented by a UE 115-h, which may be an example of the UEs 115 as described with reference to FIGS. 1 and 2.

In some examples, a signaling diagram 602 illustrates a periodic multiple combined grants without request. At 604, the UE 115-h may transmit a capability report that pertains to object detection and object classification. At 606, the UE 115-h may receive a grant of periodic multiple detection and classification beams based on the capability report. For example, UE 115-h may receive, from the network entity 105-h, a network grant that schedules periodic object detection via multiple detection beams and that schedules periodic object classification via multiple classification beams. In some cases, the UE 115-h may receive a single DCI or multiple DCI scheduling multiple future periodic detection beams and multiple future periodic classification beams. At 608, the UE 115-h may transmit one or more detection beams to attempt to detect an object. At 610, if the UE 115-h detects the object using the detection beam, the UE 115-h may transmit one or more classification beams to attempt to classify the object, such as classify or identify the object as human tissue. At 612, the UE 115-h may transmit one or more detection beams to attempt to detect an object. At 614, if the UE 115-h detects the object using the detection beam, the UE 115-h may transmit one or more classification beams to attempt to classify the object, such as classify or identify the object as human tissue.

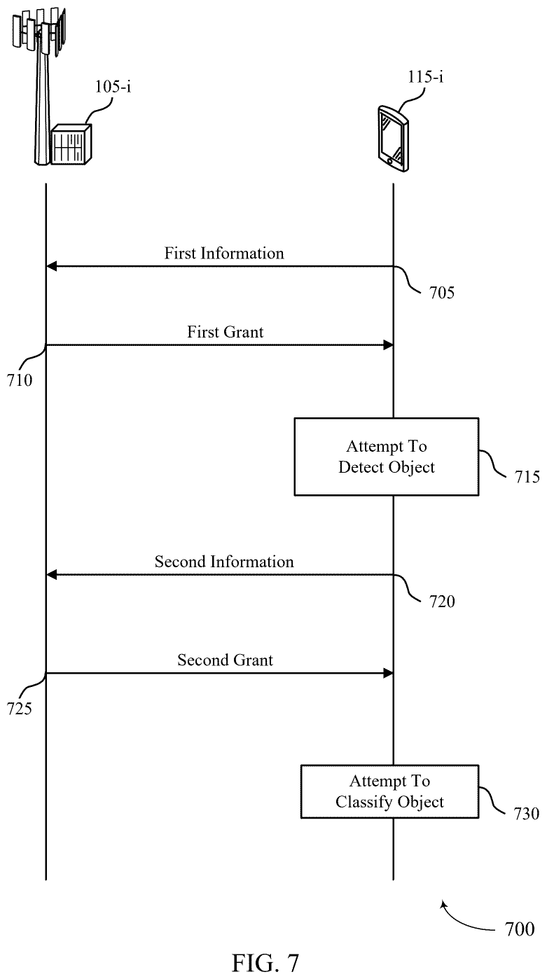

FIG. 7 shows an example of a process flow 700 that supports techniques for MPE compliance in accordance with one or more aspects of the present disclosure. In some examples, the process flow 700 may implement or be implemented by aspects of the wireless communications systems 100 and 200 as described with reference to FIGS. 1 and 2, respectively. For example, the process flow 700 may be implemented by a network entity 105-i, which may be an example of the network entities 105 as described with reference to FIGS. 1 and 2. The process flow 700 may be implemented by a UE 115-i, which may be an example of the UEs as described with reference to FIGS. 1 and 2.

In some examples, the operations illustrated in process flow 700 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 705, the UE 115-i may transmit first information that pertains to at least one of object detection or object classification.

At 710, the UE 115-i may receive, responsive to the first information, a first grant that schedules object detection via one or more first detection beams. The one or more first detection beams may be indicated to the UE 115-i separate from one or more first classification beams. In some examples, the one or more first detection beams may be a beam in a mmW frequency range or a sub-THz frequency range. In some examples, the one or more first classification beams may be a beam in a sub-THz frequency range. In some examples, the first information may include a first request for a detection beam grant, and the first grant may be responsive to the first request for the detection beam grant.

In some examples, the first information may include a first request for a detection beam grant and a classification beam grant. The first grant may be responsive to the first request for the detection beam grant and the classification beam grant. The first grant schedules object classification via the one or more first classification beams. In some examples, the first grant may be a plurality of grants that are collectively responsive to the first request, and each of the plurality of grants may schedule respective beams of the one or more first detection beams or the one or more first classification beams. In some examples, the UE 115-i may attempt, based at least in part on detection of the object using the one or more first detection beams, to classify the object using the one or more first classification beams.

In some examples, the first information may include a first request for a plurality of detection beams grants. The first grant may be a plurality of grants that are collectively responsive to the first request, and each of the plurality of grants may schedule respective beams of the one or more first detection beams.

In some examples, the first information may include a first request for a plurality of a detection beam grants and a plurality a classification beam grants for classification of the object. The first grant may be a plurality of detection beam grants and a plurality of classification beam grants that are collectively responsive to the first request. Each of the plurality of detection beam grants may schedule respective beams of the one or more first detection beams and each of the plurality of classification beam grants schedules respective beams of the one or more first classification beams.

In some examples, the first information includes a first request for a periodic detection beam grant and a periodic classification beam grant. The first grant may be responsive to the first request for the periodic detection beam grant and the periodic classification beam grant. The first grant schedules periodic object detection via the one or more first detection beams, and the first grant schedules periodic object classification via the one or more first classification beams. The first grant may be a plurality of grants that are collectively responsive to the first request, and each of the plurality of grants schedules respective beams of the one or more first detection beams or the one or more first classification beams. In some examples, the UE 115-i may transmit, subsequent to receiving the first grant, second information that indicates a request to end the periodic detection beam grant and the periodic classification beam grant.

In some examples, the first information may include a capability report that pertains to object detection and object classification. The first grant may schedule periodic object detection via the one or more first detection beams and periodic object classification via the one or more first classification beams based at least in part on the capability report. The first grant may be a plurality of grants that are collectively responsive to the first request, and each of the plurality of grants schedules respective beams of the one or more first detection beams or the one or more first classification beams.

At 715, the UE 115-i may attempting to detect an object using the one or more first detection beams. In some examples, the UE 115-i may attempt, subsequent using the one or more first detection beams, to detect the object using the one or more first detection beams

At 720, the UE 115-i may transmit, based at least in part on detection of the object using the one or more first detection beams, second information that includes a second request for a classification beam grant for classification of the object.

At 725, the UE 115-i may receive, responsive to the second information, a second grant that schedules object classification via the one or more first classification beams.

At 730, the UE 115-i may attempt to classify the object using the one or more first classification beams. In some examples, the UE 115-i may attempt, subsequent using the one or more first classification beams, to detect the object using the one or more first detection beams. In some examples, the UE 115-i may comply with a MPE restriction based on classification of the object using the one or more first classification beams. In some examples, to comply with the MPE restriction, the UE 115-i may refrain from transmitting a beam that is directed to the object. In some examples, to comply with the MPE restriction, the UE 115-i may transmit a beam that is directed to the object at higher power backoff or a lower duty cycle than a beam that is directed away from the object.

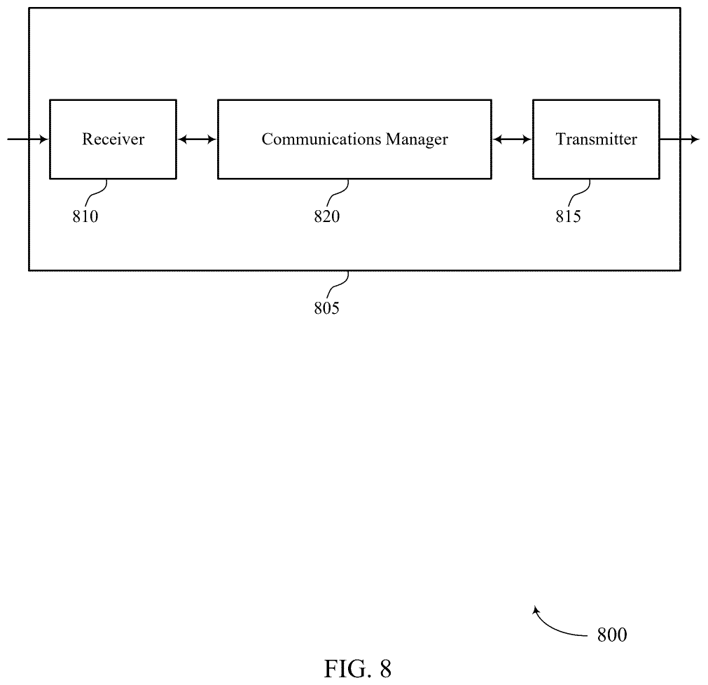

FIG. 8 shows a block diagram 800 of a device 805 that supports techniques for MPE compliance in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for MPE compliance). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for MPE compliance). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of techniques for MPE compliance as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting first information that pertains to at least one of object detection or object classification. The communications manager 820 is capable of, configured to, or operable to support a means for receiving, responsive to the first information, a first grant that schedules object detection via one or more first detection beams, where the one or more first detection beams are indicated to the UE separate from one or more first classification beams. The communications manager 820 is capable of, configured to, or operable to support a means for attempting to detect an object using the one or more first detection beams.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

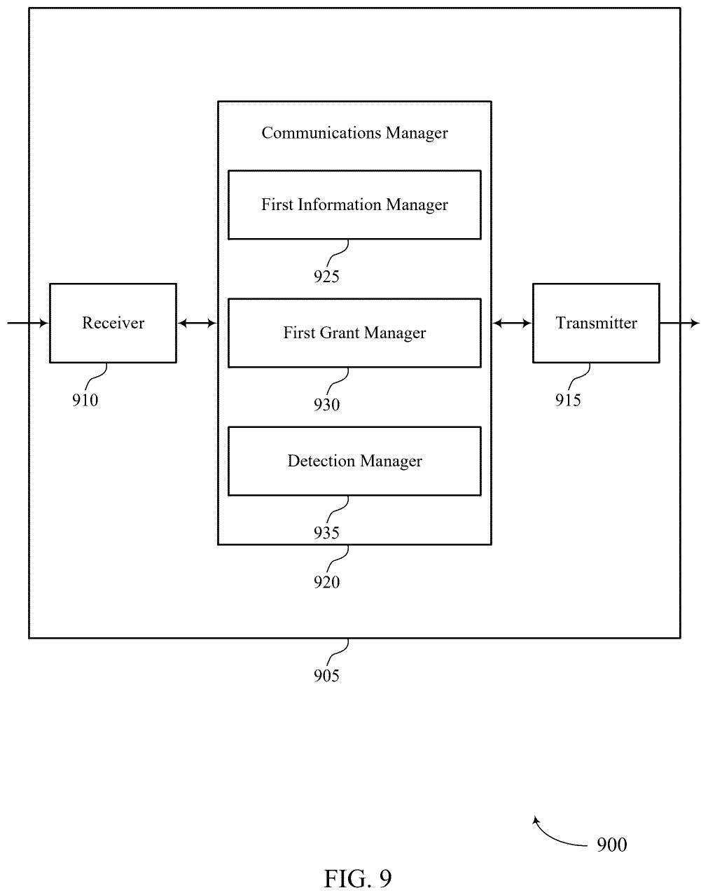

FIG. 9 shows a block diagram 900 of a device 905 that supports techniques for MPE compliance in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for MPE compliance). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for MPE compliance). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for MPE compliance as described herein. For example, the communications manager 920 may include a first information manager 925, a first grant manager 930, an object detection manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The first information manager 925 is capable of, configured to, or operable to support a means for transmitting first information that pertains to at least one of object detection or object classification. The first grant manager 930 is capable of, configured to, or operable to support a means for receiving, responsive to the first information, a first grant that schedules object detection via one or more first detection beams, where the one or more first detection beams are indicated to the UE separate from one or more first classification beams. The object detection manager 935 is capable of, configured to, or operable to support a means for attempting to detect an object using the one or more first detection beams.

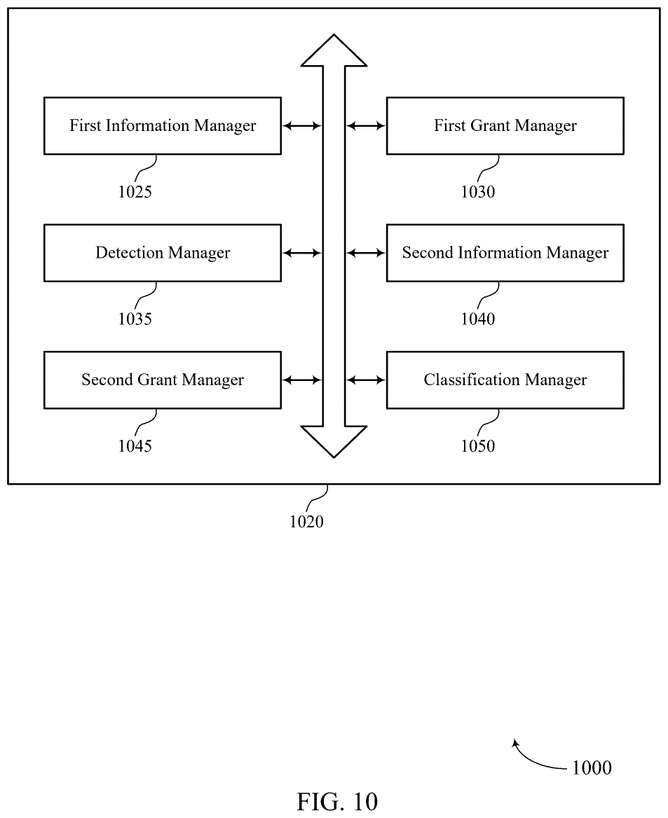

FIG. 10 shows a block diagram 1000 of a communications manager 1020 that supports techniques for MPE compliance in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for MPE compliance as described herein. For example, the communications manager 1020 may include a first information manager 1025, a first grant manager 1030, an object detection manager 1035, a second information manager 1040, a second grant manager 1045, an object classification manager 1050, a maximum permissible exposure manager 1055 or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The first information manager 1025 is capable of, configured to, or operable to support a means for transmitting first information that pertains to at least one of object detection or object classification. The first grant manager 1030 is capable of, configured to, or operable to support a means for receiving, responsive to the first information, a first grant that schedules object detection via one or more first detection beams, where the one or more first detection beams are indicated to the UE separate from one or more first classification beams. The object detection manager 1035 is capable of, configured to, or operable to support a means for attempting to detect an object using the one or more first detection beams.

In some examples, the first information includes a first request for a detection beam grant, the first grant is responsive to the first request for the detection beam grant.

In some examples, the second information manager 1040 is capable of, configured to, or operable to support a means for transmitting, based on detection of the object using the one or more first detection beams, second information that includes a second request for a classification beam grant for classification of the object. In some examples, the second grant manager 1045 is capable of, configured to, or operable to support a means for receiving, responsive to the second information, a second grant that schedules object classification via the one or more first classification beams. In some examples, the object classification manager 1050 is capable of, configured to, or operable to support a means for attempting to classify the object using the one or more first classification beams.

In some examples, the first information includes a first request for a detection beam grant and a classification beam grant, the first grant is responsive to the first request for the detection beam grant and the classification beam grant, the first grant schedules object classification via the one or more first classification beams.

In some examples, the first grant is a set of multiple grants that are collectively responsive to the first request, each of the set of multiple grants schedules respective beams of the one or more first detection beams or the one or more first classification beams.

In some examples, the object classification manager 1050 is capable of, configured to, or operable to support a means for attempting, based on detection of the object using the one or more first detection beams, to classify the object using the one or more first classification beams.

In some examples, the first information includes a first request for a set of multiple detection beam grants, the first grant is a set of multiple grants that are collectively responsive to the first request, each of the set of multiple grants schedules respective beams of the one or more first detection beams.

In some examples, the second information manager 1040 is capable of, configured to, or operable to support a means for transmitting, based on detection of the object using the one or more first detection beams, second information that includes a second request for a set of multiple classification beam grants for classification of the object. In some examples, the second grant manager 1045 is capable of, configured to, or operable to support a means for receiving, responsive to the second information, a second grant, where the second grant is a set of multiple classification beam grants that are collectively responsive to the second request, where each of the set of multiple classification beam grants schedules respective beams of the one or more first classification beams. In some examples, the object classification manager 1050 is capable of, configured to, or operable to support a means for attempting to classify the object using the one or more first classification beams.

In some examples, the first information includes a first request for a set of multiple a detection beam grants and a set of multiple classification beam grants for classification of the object, the first grant is a set of multiple detection beam grants and a set of multiple classification beam grants that are collectively responsive to the first request, each of the set of multiple detection beam grants schedules respective beams of the one or more first detection beams and each of the set of multiple classification beam grants schedules respective beams of the one or more first classification beams.

In some examples, the object classification manager 1050 is capable of, configured to, or operable to support a means for attempting to classify the object using the one or more first classification beams, the plurality of detection beam grants and the plurality of classification beam grants collectively schedules all of the respective beams of the one or more first detection beams to be used prior to use of any respective beams of the one or more first classification beams.

In some examples, the object classification manager 1050 is capable of, configured to, or operable to support a means for attempting to classify the object using the one or more first classification beams, the plurality of detection beam grants and the plurality of classification beam grants collectively schedules the respective beams of the one or more first detection beams to be used temporally interspersed with use of the respective beams of the one or more first classification beams.

In some examples, the first information includes a first request for a periodic detection beam grant and a periodic classification beam grant, the first grant is responsive to the first request for the periodic detection beam grant and the periodic classification beam grant, the first grant schedules periodic object detection via the one or more first detection beams, the first grant schedules periodic object classification via the one or more first classification beams.

In some examples, the second information manager 1040 is capable of, configured to, or operable to support a means for transmitting, subsequent to receiving the first grant, second information that indicates a request to end the periodic detection beam grant and the periodic classification beam grant.

In some examples, the first grant is a set of multiple grants that are collectively responsive to the first request, each of the set of multiple grants schedules respective beams of the one or more first detection beams or the one or more first classification beams.

In some examples, the first information includes a capability report that pertains to object detection and object classification.

In some examples, the first grant schedules periodic object detection via the one or more first detection beams and periodic object classification via the one or more first classification beams based on the capability report.

In some examples, the first grant is a set of multiple grants that are collectively responsive to the first request, each of the set of multiple grants schedules respective beams of the one or more first detection beams or the one or more first classification beam.

In some examples, object classification includes object identification.

In some examples, the object classification manager 1050 is capable of, configured to, or operable to support a means for attempting to classify the object using the one or more first classification beams based on detection of the object using the one or more first detection beams. In some examples, the maximum permissible exposure manager 1055 is capable of, configured to, or operable to support a means for complying with a MPE restriction based on classification of the object using the one or more first classification beams.

In some examples, to support complying with the MPE restriction, the maximum permissible exposure manager 1055 is capable of, configured to, or operable to support a means for refraining from transmitting a beam that is directed to the object.

In some examples, to support complying with the MPE restriction, the maximum permissible exposure manager 1055 is capable of, configured to, or operable to support a means for transmitting a beam that is directed to the object at higher power backoff or a lower duty cycle than a beam that is directed away from the object.

In some examples, the one or more first detection beams include a beam in a mmW frequency range or a sub-THz frequency range.

In some examples, the one or more first classification beams include a beam in a sub-THz frequency range.

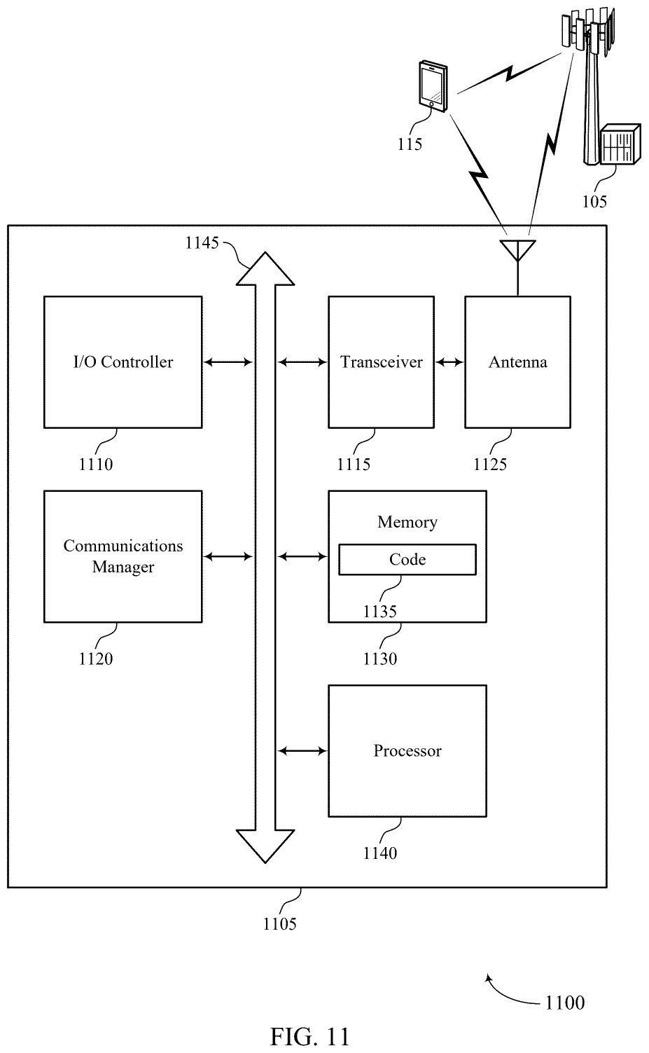

FIG. 11 shows a diagram of a system 1100 including a device 1105 that supports techniques for MPE compliance in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for MPE compliance). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting first information that pertains to at least one of object detection or object classification. The communications manager 1120 is capable of, configured to, or operable to support a means for receiving, responsive to the first information, a first grant that schedules object detection via one or more first detection beams, where the one or more first detection beams are indicated to the UE separate from one or more first classification beams. The communications manager 1120 is capable of, configured to, or operable to support a means for attempting to detect an object using the one or more first detection beams.

By including or configuring the communications manager 1120 in accordance with examples as described herein, the device 1105 may support techniques for more efficient utilization of communication resources and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for MPE compliance as described herein, or the at least one processor 1140 and the at least one memory 1130 may be otherwise configured to, individually or collectively, perform or support such operations.

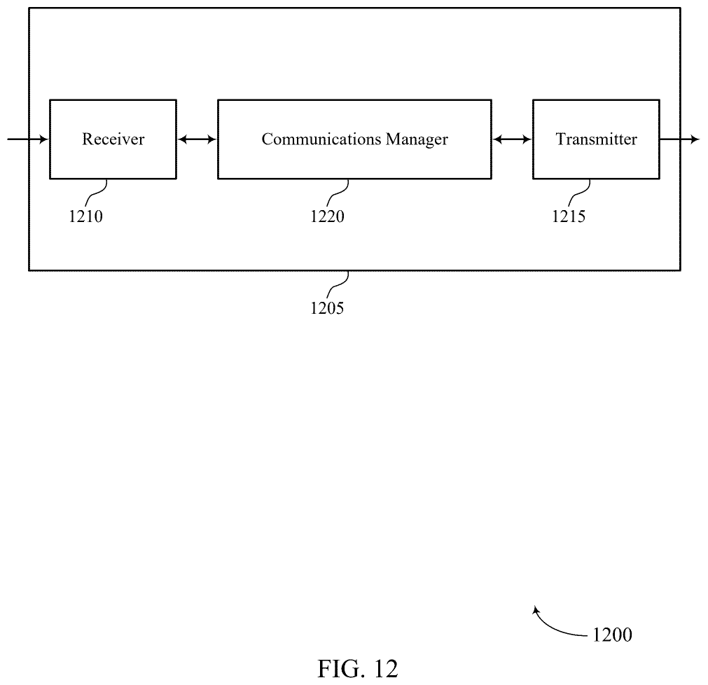

FIG. 12 shows a block diagram 1200 of a device 1205 that supports techniques for MPE compliance in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of techniques for MPE compliance as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for obtaining first information that pertains to at least one of object detection or object classification. The communications manager 1220 is capable of, configured to, or operable to support a means for outputting, responsive to the first information, a first grant that schedules object detection via one or more first detection beams, where the one or more first detection beams are indicated to the UE separate from one or more first classification beams.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for more efficient utilization of communication resources.

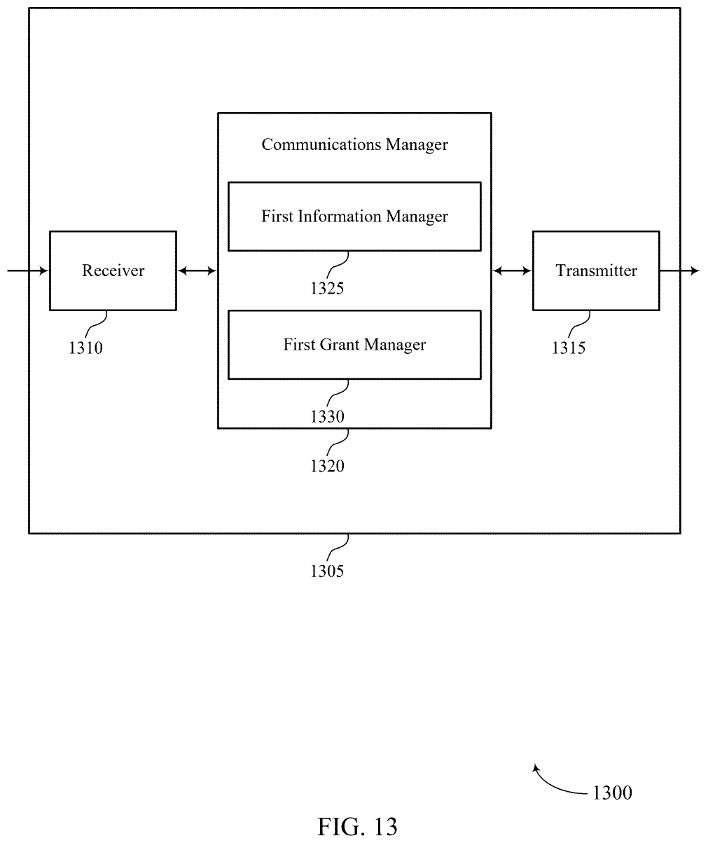

FIG. 13 shows a block diagram 1300 of a device 1305 that supports techniques for MPE compliance in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for MPE compliance as described herein. For example, the communications manager 1320 may include a first information manager 1325 a first grant manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The first information manager 1325 is capable of, configured to, or operable to support a means for obtaining first information that pertains to at least one of object detection or object classification. The first grant manager 1330 is capable of, configured to, or operable to support a means for outputting, responsive to the first information, a first grant that schedules object detection via one or more first detection beams, where the one or more first detection beams are indicated to the UE separate from one or more first classification beams.

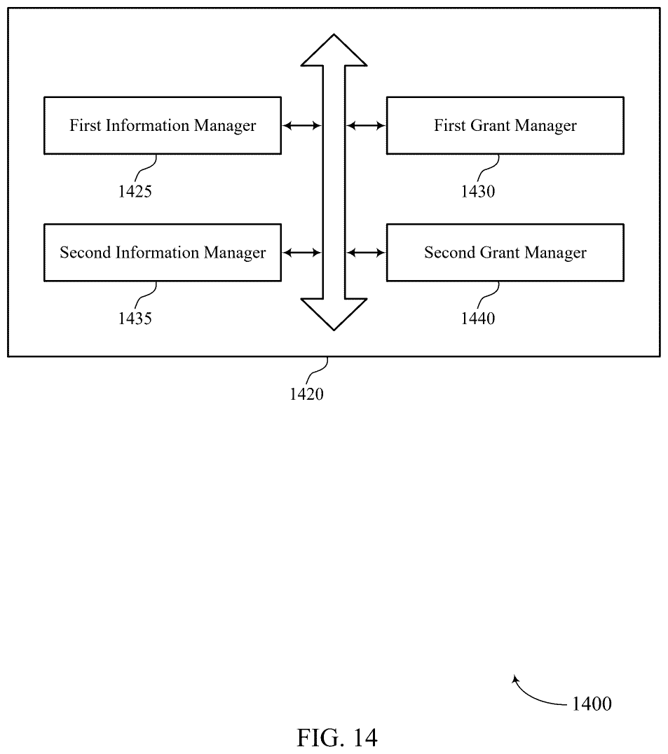

FIG. 14 shows a block diagram 1400 of a communications manager 1420 that supports techniques for MPE compliance in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for MPE compliance as described herein. For example, the communications manager 1420 may include a first information manager 1425, a first grant manager 1430, a second information manager 1435, a second grant manager 1440, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The first information manager 1425 is capable of, configured to, or operable to support a means for obtaining first information that pertains to at least one of object detection or object classification. The first grant manager 1430 is capable of, configured to, or operable to support a means for outputting, responsive to the first information, a first grant that schedules object detection via one or more first detection beams, where the one or more first detection beams are indicated to the UE separate from one or more first classification beams.

In some examples, the first information includes a first request for a detection beam grant, the first grant is responsive to the first request for the detection beam grant.

In some examples, the second information manager 1435 is capable of, configured to, or operable to support a means for obtaining, subsequent the first information, second information that includes a second request for a classification beam grant for classification of an object. In some examples, the second grant manager 1440 is capable of, configured to, or operable to support a means for outputting, responsive to the second information, a second grant that schedules object classification via the one or more first classification beams.

In some examples, the first information includes a first request for a set of multiple detection beam grants, the first grant is a set of multiple grants that are collectively responsive to the first request, each of the set of multiple grants schedules respective beams of the one or more first detection beams.

In some examples, the second information manager 1435 is capable of, configured to, or operable to support a means for obtaining, subsequent the first information, second information that includes a second request for a set of multiple classification beam grants for classification of an object. In some examples, the second grant manager 1440 is capable of, configured to, or operable to support a means for outputting, responsive to the second information, a second grant, where the second grant is a set of multiple classification beam grants that are collectively responsive to the second request, where each of the set of multiple classification beam grants schedules respective beams of the one or more first classification beams.

In some examples, the first information includes a first request for a set of multiple detection beam grants and a set of multiple classification beam grants for classification of an object, the first grant is a set of multiple detection beam grants and a set of multiple classification beam grants that are collectively responsive to the first request, each of the set of multiple detection beam grants schedules respective beams of the one or more first detection beams and each of the set of multiple classification beam grants schedules respective beams of the one or more first classification beams.

In some examples, the first information includes a first request for a periodic detection beam grant and a periodic classification beam grant, the first grant is responsive to the first request for the periodic detection beam grant and the periodic classification beam grant, the first grant schedules periodic object detection via the one or more first detection beams, the first grant schedules periodic object classification via the one or more first classification beams.

In some examples, the second information manager 1435 is capable of, configured to, or operable to support a means for obtaining, subsequent to the first information, second information that indicates a request to end the periodic detection beam grant and the periodic classification beam grant.

In some examples, the first grant is a set of multiple grants that are collectively responsive to the first request, each of the set of multiple grants schedules respective beams of the one or more first detection beams or the one or more first classification beams.

In some examples, the first information includes a capability report that pertains to object detection and object classification.

In some examples, the first grant schedules periodic object detection via the one or more first detection beams and periodic object classification via the one or more first classification beams based on the capability report.

In some examples, the first grant is a set of multiple grants that are collectively responsive to the first request, each of the set of multiple grants schedules respective beams of the one or more first detection beams or the one or more first classification beams.

In some examples, object classification includes object identification.

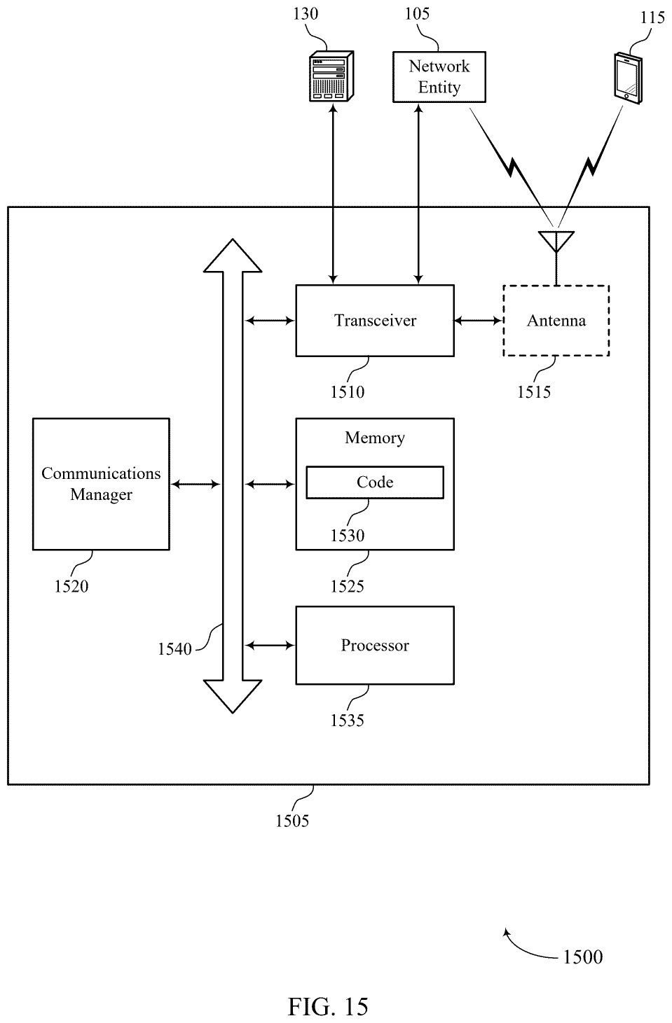

FIG. 15 shows a diagram of a system 1500 including a device 1505 that supports techniques for MPE compliance in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting techniques for MPE compliance). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for obtaining first information that pertains to at least one of object detection or object classification. The communications manager 1520 is capable of, configured to, or operable to support a means for outputting, responsive to the first information, a first grant that schedules object detection via one or more first detection beams, where the one or more first detection beams are indicated to the UE separate from one or more first classification beams.

By including or configuring the communications manager 1520 in accordance with examples as described herein, the device 1505 may support techniques for more efficient utilization of communication resources and improved coordination between devices.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of techniques for MPE compliance as described herein, or the at least one processor 1535 and the at least one memory 1525 may be otherwise configured to, individually or collectively, perform or support such operations.

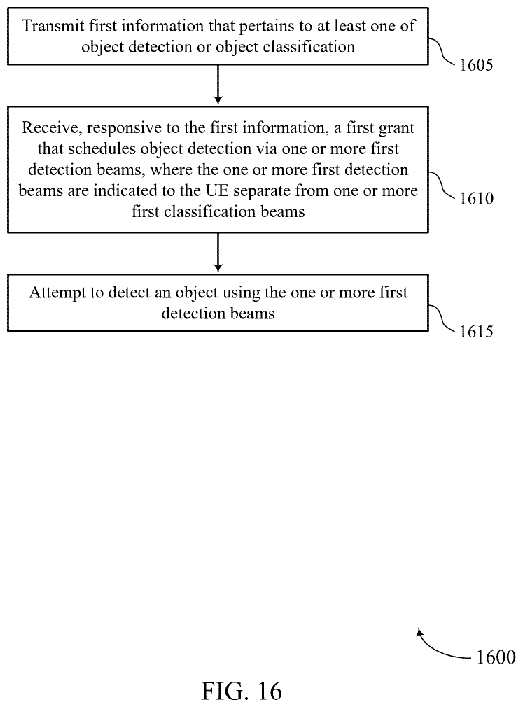

FIG. 16 shows a flowchart illustrating a method 1600 that supports techniques for MPE compliance in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include transmitting first information that pertains to at least one of object detection or object classification. The operations of 1605 may be performed in accordance with examples as disclosed herein. In some examples, aspects of the operations of 1605 may be performed by a first information manager 1025 as described with reference to FIG. 10.

At 1610, the method may include receiving, responsive to the first information, a first grant that schedules object detection via one or more first detection beams, where the one or more first detection beams are indicated to the UE separate from one or more first classification beams. The operations of 1610 may be performed in accordance with examples as disclosed herein. In some examples, aspects of the operations of 1610 may be performed by a first grant manager 1030 as described with reference to FIG. 10.

At 1615, the method may include attempting to detect an object using the one or more first detection beams. The operations of 1615 may be performed in accordance with examples as disclosed herein. In some examples, aspects of the operations of 1615 may be performed by an object detection manager 1035 as described with reference to FIG. 10.

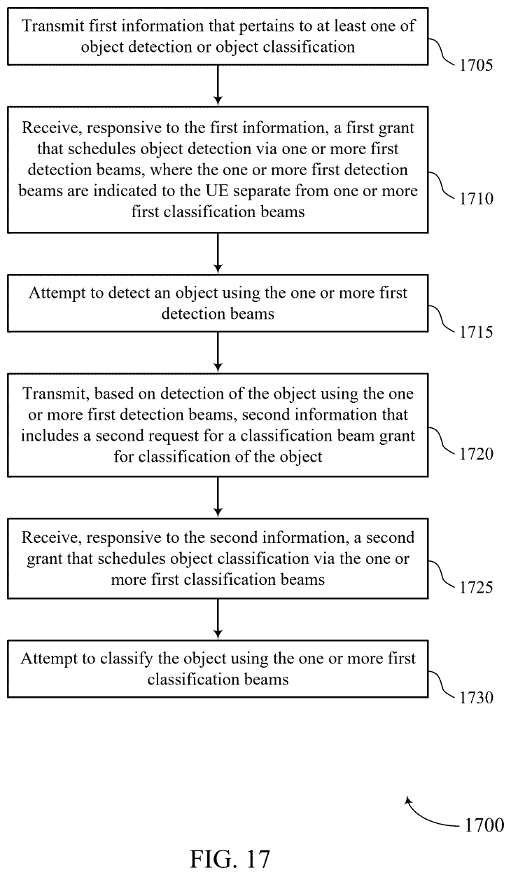

FIG. 17 shows a flowchart illustrating a method 1700 that supports techniques for MPE compliance in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include transmitting first information that pertains to at least one of object detection or object classification. The operations of 1705 may be performed in accordance with examples as disclosed herein. In some examples, aspects of the operations of 1705 may be performed by a first information manager 1025 as described with reference to FIG. 10.

At 1710, the method may include receiving, responsive to the first information, a first grant that schedules object detection via one or more first detection beams, where the one or more first detection beams are indicated to the UE separate from one or more first classification beams. The operations of 1710 may be performed in accordance with examples as disclosed herein. In some examples, aspects of the operations of 1710 may be performed by a first grant manager 1030 as described with reference to FIG. 10.

At 1715, the method may include attempting to detect an object using the one or more first detection beams. The operations of 1715 may be performed in accordance with examples as disclosed herein. In some examples, aspects of the operations of 1715 may be performed by an object detection manager 1035 as described with reference to FIG. 10.

At 1720, the method may include transmitting, based on detection of the object using the one or more first detection beams, second information that includes a second request for a classification beam grant for classification of the object. The operations of 1720 may be performed in accordance with examples as disclosed herein. In some examples, aspects of the operations of 1720 may be performed by a second information manager 1040 as described with reference to FIG. 10.

At 1725, the method may include receiving, responsive to the second information, a second grant that schedules object classification via the one or more first classification beams. The operations of 1725 may be performed in accordance with examples as disclosed herein. In some examples, aspects of the operations of 1725 may be performed by a second grant manager 1045 as described with reference to FIG. 10.

At 1730, the method may include attempting to classify the object using the one or more first classification beams. The operations of 1730 may be performed in accordance with examples as disclosed herein. In some examples, aspects of the operations of 1730 may be performed by an object classification manager 1050 as described with reference to FIG. 10.

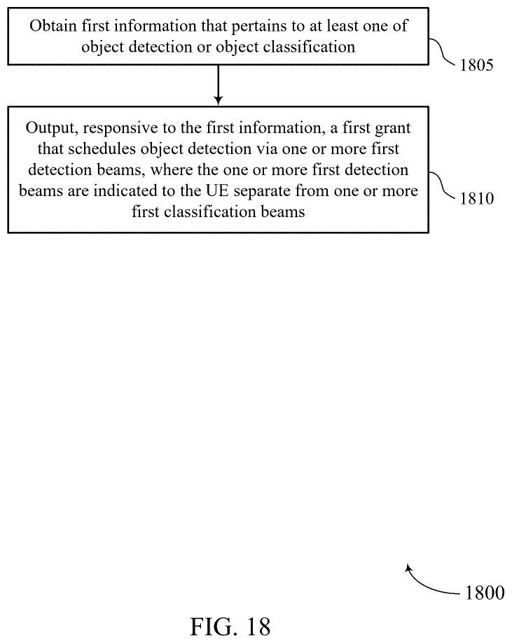

FIG. 18 shows a flowchart illustrating a method 1800 that supports techniques for MPE compliance in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include obtaining first information that pertains to at least one of object detection or object classification. The operations of 1805 may be performed in accordance with examples as disclosed herein. In some examples, aspects of the operations of 1805 may be performed by a first information manager 1425 as described with reference to FIG. 14.

At 1810, the method may include outputting, responsive to the first information, a first grant that schedules object detection via one or more first detection beams, where the one or more first detection beams are indicated to the UE separate from one or more first classification beams. The operations of 1810 may be performed in accordance with examples as disclosed herein. In some examples, aspects of the operations of 1810 may be performed by a first grant manager 1430 as described with reference to FIG. 14.

The following provides an overview of aspects of the present disclosure:

Aspect 1: A method for wireless communications by a UE, comprising: transmitting first information that pertains to at least one of object detection or object classification; receiving, responsive to the first information, a first grant that schedules object detection via one or more first detection beams, wherein the one or more first detection beams are indicated to the UE separate from one or more first classification beams; and attempting to detect an object using the one or more first detection beams.

Aspect 2: The method of aspect 1, wherein the first information includes a first request for a detection beam grant, the first grant is responsive to the first request for the detection beam grant.

Aspect 3: The method of aspect 2, further comprising: transmitting, based at least in part on detection of the object using the one or more first detection beams, second information that includes a second request for a classification beam grant for classification of the object; receiving, responsive to the second information, a second grant that schedules object classification via the one or more first classification beams; and attempting to classify the object using the one or more first classification beams.

Aspect 4: The method of aspect 1, wherein the first information includes a first request for a detection beam grant and a classification beam grant, the first grant is responsive to the first request for the detection beam grant and the classification beam grant, the first grant schedules object classification via the one or more first classification beams.

Aspect 5: The method of aspect 4, wherein the first grant is a plurality of grants that are collectively responsive to the first request, each of the plurality of grants schedules respective beams of the one or more first detection beams or the one or more first classification beams.

Aspect 6: The method of any of aspects 4 through 5, further comprising: attempting, based at least in part on detection of the object using the one or more first detection beams, to classify the object using the one or more first classification beams.

Aspect 7: The method of aspect 1, wherein the first information includes a first request for a plurality of detection beam grants, the first grant is a plurality of grants that are collectively responsive to the first request, each of the plurality of grants schedules respective beams of the one or more first detection beams.

Aspect 8: The method of aspect 7, further comprising: transmitting, based at least in part on detection of the object using the one or more first detection beams, second information that includes a second request for a plurality of classification beam grants for classification of the object; receiving, responsive to the second information, a second grant, wherein the second grant is a plurality of classification beam grants that are collectively responsive to the second request, wherein each of the plurality of classification beam grants schedules respective beams of the one or more first classification beams; and attempting to classify the object using the one or more first classification beams.

Aspect 9: The method of aspect 1, wherein the first information includes a first request for a plurality of a detection beam grants and a plurality of classification beam grants for classification of the object, the first grant is a plurality of detection beam grants and a plurality of classification beam grants that are collectively responsive to the first request, each of the plurality of detection beam grants schedules respective beams of the one or more first detection beams and each of the plurality of classification beam grants schedules respective beams of the one or more first classification beams.

Aspect 10: The method of aspect 9, further comprising: attempting to classify the object using the one or more first classification beams, wherein the plurality of detection beam grants and the plurality of classification beam grants collectively schedules all of the respective beams of the one or more first detection beams to be used prior to use of any respective beams of the one or more first classification beams.

Aspect 11: The method of any of aspects 9 through 10, further comprising: attempting to classify the object using the one or more first classification beams, wherein the plurality of detection beam grants and the plurality of classification beam grants collectively schedules the respective beams of the one or more first detection beams to be used temporally interspersed with use of the respective beams of the one or more first classification beams.

Aspect 12: The method of aspect 1, wherein the first information includes a first request for a periodic detection beam grant and a periodic classification beam grant, the first grant is responsive to the first request for the periodic detection beam grant and the periodic classification beam grant, the first grant schedules periodic object detection via the one or more first detection beams, and the first grant schedules periodic object classification via the one or more first classification beams.

Aspect 13: The method of aspect 12, further comprising: transmitting, subsequent to receiving the first grant, second information that indicates a request to end the periodic detection beam grant and the periodic classification beam grant.

Aspect 14: The method of any of aspects 12 through 13, wherein the first grant is a plurality of grants that are collectively responsive to the first request, each of the plurality of grants schedules respective beams of the one or more first detection beams or the one or more first classification beams.

Aspect 15: The method of aspect 1, wherein the first information includes a capability report that pertains to object detection and object classification.

Aspect 16: The method of aspect 15, wherein the first grant schedules periodic object detection via the one or more first detection beams and periodic object classification via the one or more first classification beams based at least in part on the capability report.

Aspect 17: The method of aspect 16, wherein the first grant is a plurality of grants that are collectively responsive to the first request, each of the plurality of grants schedules respective beams of the one or more first detection beams or the one or more first classification beam.

Aspect 18: The method of any of aspects 1 through 17, wherein object classification includes object identification.

Aspect 19: The method of aspect 1, further comprising: attempting to classify the object using the one or more first classification beams based at least in part on detection of the object using the one or more first detection beams; and complying with a MPE restriction based at least in part on classification of the object using the one or more first classification beams.

Aspect 20: The method of aspect 19, wherein complying with the MPE restriction further comprises: refraining from transmitting a beam that is directed to the object.

Aspect 21: The method of aspect 19, wherein complying with the MPE restriction further comprises: transmitting a beam that is directed to the object at higher power backoff or a lower duty cycle than a beam that is directed away from the object

Aspect 22: The method of any of aspects 1 through 21, wherein the one or more first detection beams comprise a beam in a mmW frequency range or a sub-THz frequency range.

Aspect 23: The method of any of aspects 1 through 22, wherein the one or more first classification beams comprise a beam in a sub-THz frequency range.

Aspect 24: A method for wireless communications by a network entity, comprising: obtaining first information that pertains to at least one of object detection or object classification; and outputting, responsive to the first information, a first grant that schedules object detection via one or more first detection beams, wherein the one or more first detection beams are indicated to the UE separate from one or more first classification beams.

Aspect 25: The method of aspect 24, wherein the first information includes a first request for a detection beam grant, the first grant is responsive to the first request for the detection beam grant.

Aspect 26: The method of aspect 25, further comprising: obtaining, subsequent the first information, second information that includes a second request for a classification beam grant for classification of an object; and outputting, responsive to the second information, a second grant that schedules object classification via the one or more first classification beams.

Aspect 27: The method of any of aspects 24 through 26, wherein the first information includes a first request for a plurality of detection beam grants, the first grant is a plurality of grants that are collectively responsive to the first request, each of the plurality of grants schedules respective beams of the one or more first detection beams.

Aspect 28: The method of aspect 27, further comprising: obtaining, subsequent the first information, second information that includes a second request for a plurality of classification beam grants for classification of an object; and outputting, responsive to the second information, a second grant, wherein the second grant is a plurality of classification beam grants that are collectively responsive to the second request, wherein each of the plurality of classification beam grants schedules respective beams of the one or more first classification beams.

Aspect 29: The method of any of aspects 24 through 28, wherein the first information includes a first request for a plurality of detection beam grants and a plurality of classification beam grants for classification of an object, the first grant is a plurality of detection beam grants and a plurality of classification beam grants that are collectively responsive to the first request, each of the plurality of detection beam grants schedules respective beams of the one or more first detection beams and each of the plurality of classification beam grants schedules respective beams of the one or more first classification beams.

Aspect 30: The method of any of aspects 24 through 29, wherein the first information includes a first request for a periodic detection beam grant and a periodic classification beam grant, the first grant is responsive to the first request for the periodic detection beam grant and the periodic classification beam grant, the first grant schedules periodic object detection via the one or more first detection beams, the first grant schedules periodic object classification via the one or more first classification beams.

Aspect 31: The method of aspect 30, further comprising: obtaining, subsequent to the first information, second information that indicates a request to end the periodic detection beam grant and the periodic classification beam grant.

Aspect 32: The method of any of aspects 30 through 31, wherein the first grant is a plurality of grants that are collectively responsive to the first request, each of the plurality of grants schedules respective beams of the one or more first detection beams or the one or more first classification beams.

Aspect 33: The method of any of aspects 24 through 32, wherein the first information includes a capability report that pertains to object detection and object classification.

Aspect 34: The method of aspect 33, wherein the first grant schedules periodic object detection via the one or more first detection beams and periodic object classification via the one or more first classification beams based at least in part on the capability report.

Aspect 35: The method of any of aspects 33 through 34, wherein the first grant is a plurality of grants that are collectively responsive to the first request, each of the plurality of grants schedules respective beams of the one or more first detection beams or the one or more first classification beams.

Aspect 36: The method of any of aspects 24 through 35, wherein object classification includes object identification.

Aspect 37: A UE for wireless communications, comprising one or more memories storing processor-executable code, and one or more processors coupled with the one or more memories and individually or collectively operable to execute the code to cause the UE to perform a method of any of aspects 1 through 23.

Aspect 38: A UE for wireless communications, comprising at least one means for performing a method of any of aspects 1 through 23.

Aspect 39: A non-transitory computer-readable medium storing code for wireless communications, the code comprising instructions executable by one or more processors to perform a method of any of aspects 1 through 23.

Aspect 40: A network entity for wireless communications, comprising one or more memories storing processor-executable code, and one or more processors coupled with the one or more memories and individually or collectively operable to execute the code to cause the network entity to perform a method of any of aspects 24 through 36.

Aspect 41: A network entity for wireless communications, comprising at least one means for performing a method of any of aspects 24 through 36.

Aspect 42: A non-transitory computer-readable medium storing code for wireless communications, the code comprising instructions executable by one or more processors to perform a method of any of aspects 24 through 36.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit first information that pertains to at least one of object detection or object classification;
receive, responsive to the first information, a first grant that schedules object detection via one or more first detection beams, wherein the one or more first detection beams are indicated to the UE separate from one or more first classification beams; and
attempt to detect an object using the one or more first detection beams.

2. The UE of claim 1, wherein the one or more processors are individually or collectively further operable to execute the code to cause the UE to:
attempt to classify the object using the one or more first classification beams based at least in part on detection of the object using the one or more first detection beams; and
comply with a maximum permissible exposure restriction based at least in part on classification of the object using the one or more first classification beams.

3. The UE of claim 2, wherein, to comply with the maximum permissible exposure restriction, the one or more processors are individually or collectively further operable to execute the code to cause the UE to:
refrain from transmitting a beam that is directed to the object.

4. The UE of claim 2, wherein, to comply with the maximum permissible exposure restriction, the one or more processors are individually or collectively further operable to execute the code to cause the UE to:
transmit a beam that is directed to the object at higher power backoff or a lower duty cycle than a beam that is directed away from the object.

5. The UE of claim 1, wherein the one or more first detection beams comprise a beam in a millimeter wave frequency range or a sub-terahertz frequency range.

6. The UE of claim 1, wherein the one or more first classification beams comprise a beam in a sub-terahertz frequency range.

7. The UE of claim 1, wherein the first information includes a first request for a detection beam grant, the first grant is responsive to the first request for the detection beam grant.

8. The UE of claim 7, wherein the one or more processors are individually or collectively further operable to execute the code to cause the UE to:
transmit, based at least in part on detection of the object using the one or more first detection beams, second information that includes a second request for a classification beam grant for classification of the object;
receive, responsive to the second information, a second grant that schedules object classification via the one or more first classification beams; and
attempt to classify the object using the one or more first classification beams.

9. The UE of claim 1, wherein the first information includes a first request for a detection beam grant and a classification beam grant, the first grant is responsive to the first request for the detection beam grant and the classification beam grant, the first grant schedules object classification via the one or more first classification beams.

10. The UE of claim 9, wherein the first grant is a plurality of grants that are collectively responsive to the first request, each of the plurality of grants schedules respective beams of the one or more first detection beams or the one or more first classification beams.

11. The UE of claim 9, wherein the one or more processors are individually or collectively further operable to execute the code to cause the UE to:
attempt, based at least in part on detection of the object using the one or more first detection beams, to classify the object using the one or more first classification beams.

12. The UE of claim 1, wherein the first information includes a first request for a plurality of detection beam grants, the first grant is a plurality of grants that are collectively responsive to the first request, each of the plurality of grants schedules respective beams of the one or more first detection beams.

13. The UE of claim 12, wherein the one or more processors are individually or collectively further operable to execute the code to cause the UE to:
transmit, based at least in part on detection of the object using the one or more first detection beams, second information that includes a second request for a plurality of classification beam grants for classification of the object;
receive, responsive to the second information, a second grant, wherein the second grant is a plurality of classification beam grants that are collectively responsive to the second request, wherein each of the plurality of classification beam grants schedules respective beams of the one or more first classification beams; and
attempt to classify the object using the one or more first classification beams.

14. The UE of claim 1, wherein the first information includes a first request for a plurality of a detection beam grants and a plurality of classification beam grants for classification of the object, wherein the first grant is a plurality of detection beam grants and a plurality of classification beam grants that are collectively responsive to the first request, and wherein each of the plurality of detection beam grants schedules respective beams of the one or more first detection beams and each of the plurality of classification beam grants schedules respective beams of the one or more first classification beams.

15. The UE of claim 14, wherein the one or more processors are individually or collectively further operable to execute the code to cause the UE to:
attempt to classify the object using the one or more first classification beams, wherein the plurality of detection beam grants and the plurality of classification beam grants collectively schedules all of the respective beams of the one or more first detection beams to be used prior to use of any respective beams of the one or more first classification beams.

16. The UE of claim 14, wherein the one or more processors are individually or collectively further operable to execute the code to cause the UE to:
attempt to classify the object using the one or more first classification beams, wherein the plurality of detection beam grants and the plurality of classification beam grants collectively schedules the respective beams of the one or more first detection beams to be used temporally interspersed with use of the respective beams of the one or more first classification beams.

17. The UE of claim 1, wherein the first information includes a first request for a periodic detection beam grant and a periodic classification beam grant, wherein the first grant is responsive to the first request for the periodic detection beam grant and the periodic classification beam grant, wherein the first grant schedules periodic object detection via the one or more first detection beams, and wherein the first grant schedules periodic object classification via the one or more first classification beams.

18. The UE of claim 17, wherein the one or more processors are individually or collectively further operable to execute the code to cause the UE to:
transmit, subsequent to receiving the first grant, second information that indicates a request to end the periodic detection beam grant and the periodic classification beam grant.

19. The UE of claim 17, wherein the first grant is a plurality of grants that are collectively responsive to the first request, each of the plurality of grants schedules respective beams of the one or more first detection beams or the one or more first classification beams.

20. The UE of claim 1, wherein the first information includes a capability report that pertains to object detection and object classification.

21. The UE of claim 20, wherein the first grant schedules periodic object detection via the one or more first detection beams and periodic object classification via the one or more first classification beams based at least in part on the capability report.

22. The UE of claim 21, wherein the first grant is a plurality of grants that are collectively responsive to the capability report, each of the plurality of grants schedules respective beams of the one or more first detection beams or the one or more first classification beams.

23. The UE of claim 1, wherein:
object classification includes object identification.

24. A network entity, comprising:
one or more memories storing processor-executable code; and
one or more processors coupled with the one or more memories and individually or collectively operable to execute the code to cause the network entity to:
obtain first information that pertains to at least one of object detection or object classification; and
output, responsive to the first information, a first grant that schedules object detection via one or more first detection beams, wherein the one or more first detection beams are indicated separate from one or more first classification beams.

25. The network entity of claim 24, wherein the first information includes a first request for a detection beam grant, the first grant is responsive to the first request for the detection beam grant.

26. The network entity of claim 25, wherein the one or more processors are individually or collectively further operable to execute the code to cause the network entity to:
obtain, subsequent the first information, second information that includes a second request for a classification beam grant for classification of an object; and
output, responsive to the second information, a second grant that schedules object classification via the one or more first classification beams.

27. The network entity of claim 24, wherein the first information includes a first request for a plurality of detection beam grants, the first grant is a plurality of grants that are collectively responsive to the first request, each of the plurality of grants schedules respective beams of the one or more first detection beams.

28. The network entity of claim 27, wherein the one or more processors are individually or collectively further operable to execute the code to cause the network entity to:
obtain, subsequent the first information, second information that includes a second request for a plurality of classification beam grants for classification of an object; and
output, responsive to the second information, a second grant, wherein the second grant is a plurality of classification beam grants that are collectively responsive to the second request, wherein each of the plurality of classification beam grants schedules respective beams of the one or more first classification beams.

29. The network entity of claim 24, wherein the first information includes a first request for a plurality of detection beam grants and a plurality of classification beam grants for classification of an object, the first grant is a plurality of detection beam grants and a plurality of classification beam grants that are collectively responsive to the first request, each of the plurality of detection beam grants schedules respective beams of the one or more first detection beams and each of the plurality of classification beam grants schedules respective beams of the one or more first classification beams.

30. The network entity of claim 24, wherein the first information includes a first request for a periodic detection beam grant and a periodic classification beam grant, the first grant is responsive to the first request for the periodic detection beam grant and the periodic classification beam grant, the first grant schedules periodic object detection via the one or more first detection beams, the first grant schedules periodic object classification via the one or more first classification beams.

31. The network entity of claim 30, wherein the one or more processors are individually or collectively further operable to execute the code to cause the network entity to:
obtain, subsequent to the first information, second information that indicates a request to end the periodic detection beam grant and the periodic classification beam grant.

32. The network entity of claim 24, wherein the first information includes a capability report that pertains to object detection and object classification.

33. A method for wireless communications by a user equipment (UE), comprising:
transmitting first information that pertains to at least one of object detection or object classification;
receiving, responsive to the first information, a first grant that schedules object detection via one or more first detection beams, wherein the one or more first detection beams are indicated to the UE separate from one or more first classification beams; and
attempting to detect an object using the one or more first detection beams.

34. The method of claim 33, wherein the first information includes a first request for a detection beam grant, the first grant is responsive to the first request for the detection beam grant.

35. A method for wireless communications by a network entity, comprising:
obtaining first information that pertains to at least one of object detection or object classification; and
outputting, responsive to the first information, a first grant that schedules object detection via one or more first detection beams, wherein the one or more first detection beams are indicated separate from one or more first classification beams.
